(19) United States
(12) Patent Application Publication
(10) Pub. No.: US 2003/0080136 A1
(43) Pub. Date: May 1, 2003

(54) Machine for dispensing sheets of material

(75) Inventors: Graciela Santiler Nowik, Skokie, IL (US); Wai Ngai Chin, Glenview, IL (US); Gary Kobylewski, Hoffman Estates, IL (US); Yei Feng Moy, Lindenhurst, IL (US); Joseph S. Nowik, Skokie, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Avec Enterprises, Inc., Elk Grove Village, IL

(21) Appl. No.: 10/280,273

(22) Filed: Oct. 25, 2002

Related U.S. Application Data
(60) Provisional application No. 60/339,500, filed on Oct. 26, 2001.

(51) Int. Cl. B26D 1/00; B26D 3/00; G07F 11/72

(52) U.S. Cl. 221/30; 83/13

(57) ABSTRACT

Disclosed is a foil dispensing machine for use in the process of hair coloring and highlighting. The machine can accommodate a commercially available roll of metal foil and includes a motor that can be used to unwind a piece of foil from the roll and dispense the piece from the machine. The machine further includes a cutter that is used to cut the dispensed foil from the remaining foil on the roll. The components of the machine are designed and positioned to reduce the likelihood that the foil will bunch up as it is being unwound from the roll. In some embodiments, the machine also includes a control device that can be programmed or adjusted to cause the machine to dispense foil in pre-set lengths. In some embodiments, the machine may be incorporated with a piece of furniture intended for placement in a hair salon.

### CLAIM OF PRIORITY

This application claims the benefit of U.S. Provisional Application 60/339,500, filed Oct. 26, 2001, which is herein incorporated by reference.

### FIELD OF THE INVENTION

The present invention relates generally to devices for dispensing sheet material, and more particularly to motorized devices for metering and dispensing metallic foil. The invention has particular utility in the field of hair styling where a hair stylist to color or highlight hair may use it.

### BACKGROUND OF THE INVENTION

Currently, the process of coloring or highlighting hair is labor intensive and time consuming. The procedure requires that a hair stylist first group together a lock of hair intended to be colored. The stylist then places around each grouped lock of hair a trimmed piece of metal foil and applies a coloring solution to the lock. The foil is thin and malleable and can be easily folded about the lock of hair. The stylist repeats this procedure until the desired amount of hair has been treated. Since both of the stylist's hands are occupied, to facilitate the coloring process, the stylist typically uses pre-cut pieces of metallic foil that have been trimmed to the appropriate lengths for the customer's unique hair.

To produce the pre-cut foil pieces, the stylist typically must trim the metallic foil from commercially available rolled sheets before beginning the coloring process. Importantly, the stylist must correctly estimate the appropriate number and sizes of foil pieces needed to carry the coloring process through to completion. This sacrifices the stylist's ability to customize the size of the foil pieces for each particular application. In other instances, some upscale salons hire assistants dedicated to tearing foil by hand during the coloring process. The above measures for pre-cutting foil are inefficient, expensive, and/or time consuming.

Thus, there is a need for an efficient and reliable way of providing the trimmed foil pieces for use in coloring and highlighting hair. There is also a need for a way of enabling a stylist to produce customized sizes of the foil pieces as they are needed.

### SUMMARY OF THE INVENTION

The present invention overcomes the identified problems by providing a machine that can dispense and cut readily available rolls of foil to provide ready-for-use foil pieces for hair coloring and highlighting. The machine is sized and configured to be located inside a salon within easy access of the hair stylist conducting the coloring process. Moreover, for customizing the hair coloring process to a particular style, the machine enables the hair stylist to dispense strips of foil at any length desired.

The machine includes a supporter that can accommodate a commercially available roll of metallic foil typically used in hair coloring and highlighting procedures. To remove foil from the roll, the machine further includes a driver that cooperates with a motor to unwind the foil from the roll, advance the foil through the device, and ultimately dispense it from the device. A cutter is placed at a suitable location along the path that the foil advances to detach the foil from the remainder of the roll. Because the foil, being thin and malleable, can be easily distorted, the supporter, driver, cutter, and other components of the machine are configured to reduce or eliminate wrinkling and mishandling of the foil as it advances through the machine.

To govern the motor that is responsible for dispensing the foil, the machine may include a control device. In some embodiments, the control device is a programmable controller. The stylist can program the controller to advance the motor for a specified duration of time in order to dispense the desired length of the foil. Multiple memory keys are provided that allows the hair stylist to store a number of pre-selected lengths into the device. To dispense foil at a random length without activating one of the memory keys, a continuous feed feature is included. Once triggered, the feed feature dispenses foil until the triggering mechanism is released.

To free the stylist's hands and to facilitate operation of the foil dispensing machine, in some embodiments the control device includes a foot pedal switch. The foot pedal switch can be set to trigger either one of the memory keys, the feed feature, or to otherwise govern the motor. In some embodiments, the machine may be incorporated into a furniture piece that is functionally designed for placement inside a salon.

Thus, an advantage of the present invention is that it provides a machine that can produce trimmed foil pieces for coloring or highlighting hair. The machine can be located in a hair salon in close proximity to the stylist's work area. Another advantage is that the machine makes use of readily available rolls of foil to produce the trimmed foil pieces. Another advantage is that the present invention enables the stylist to readily produce foil pieces with customized lengths. These and other advantages of the present invention, as well as additional inventive features, will become apparent from the description of the invention provided herein.

### BRIEF DESCRIPTION OF THE DRAWINGS

FIG. 1 is a front perspective view of a foil dispensing machine with a foot pedal switch.

FIG. 2 is a rear perspective view of the foil dispensing machine of FIG. 1 without the foot pedal switch.

FIG. 3 is an exploded perspective view of the foil dispensing machine of FIG. 1.

FIG. 4 is a side plan view of the foil dispensing machine of FIG. 1 as assembled illustrating the foil advancement path.

FIG. 5 is a detailed view of an embodiment of a user interface control panel for programming a programmable controller of the foil dispensing machine.

FIG. 6 is flow chart illustrating one embodiment of a methodology for controlling a foil dispensing machine.

FIG. 7 is a detailed view of another embodiment of a user interface control panel for controlling a foil dispensing machine.

FIG. 8 is a detailed view of another embodiment of a user interface control panel for controlling a foil dispensing machine.

FIG. 9 is an exploded perspective view of an embodiment of a foil dispensing machine that includes a tensioning roller.

FIG. 10 is a side plan view of the foil dispensing machine of FIG. 9 as assembled illustrating the foil feed path.

FIG. 11 is a perspective view of a piece of furniture in which a foil dispensing machine is accommodated.

FIG. 12 is a side cross sectional view of the furniture of FIG. 11 illustrating an internal cavity defined by the furniture.

FIG. 13 is a side cross sectional view of the furniture of FIG. 11 showing the top being opened to access the internal cavity.

### DETAILED DESCRIPTION OF THE EMBODIMENTS OF THE INVENTION

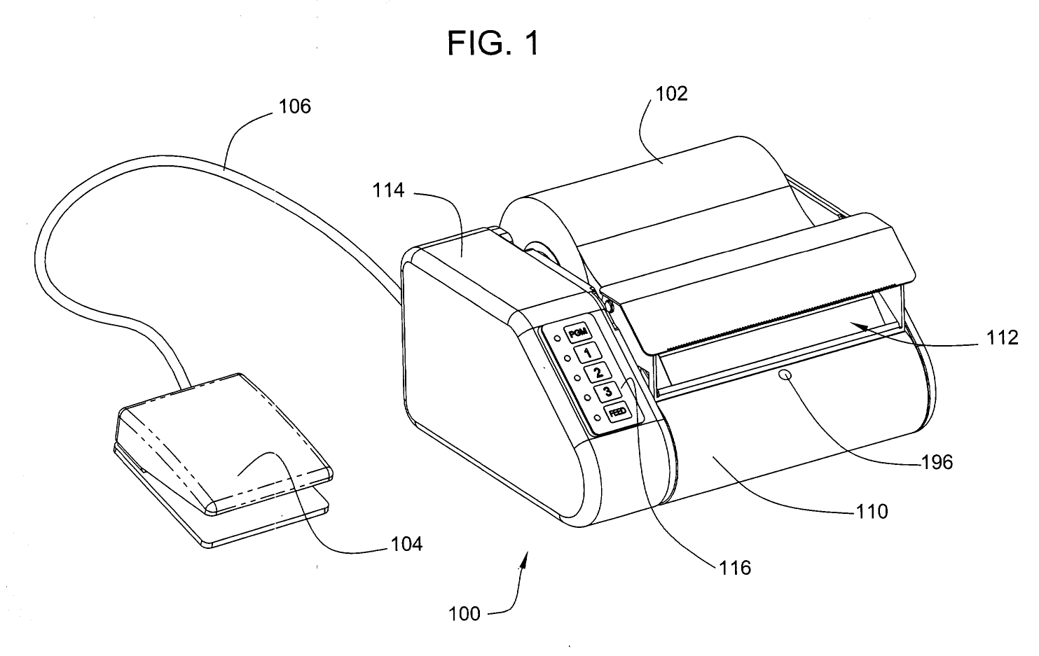

Referring now to the drawings, wherein like reference numerals refer to like elements, there is illustrated in FIG. 1 a machine 100 for dispensing metal foil to be used by a stylist while coloring or highlight hair. The foil dispensing machine is configured to accommodate a roll of wound, metallic foil 102 proximate to the top of the machine. Foil rolls are commercially available from, for example, Metal Foils, LLC of 38376 Apollo Pkwy, Willoughby, Ohio and are typically 4.00 inches in diameter by 5.00 inches long with the foil itself being 0.0005 inches thick. The rolls are typically wound about a hollow core, often made of cardboard, that has an inner diameter of about 1.31 inches and an outer diameter of about 1.66 inches. The front of the machine is defined by a front cover 110 that includes a slot 112 through which the foil pieces are dispensed.

To activate the machine, a user interface control panel 116 is located on a side cover 114 of the machine and oriented toward the front. Also provided to activate the machine is a foot pedal switch 104 configured for placement away from the machine and connected to the machine via a cable 106. Various styles of foot pedal switches are common in the art of foot pedal switches and are designed to activate mechanical machinery when triggered by an operator's foot.

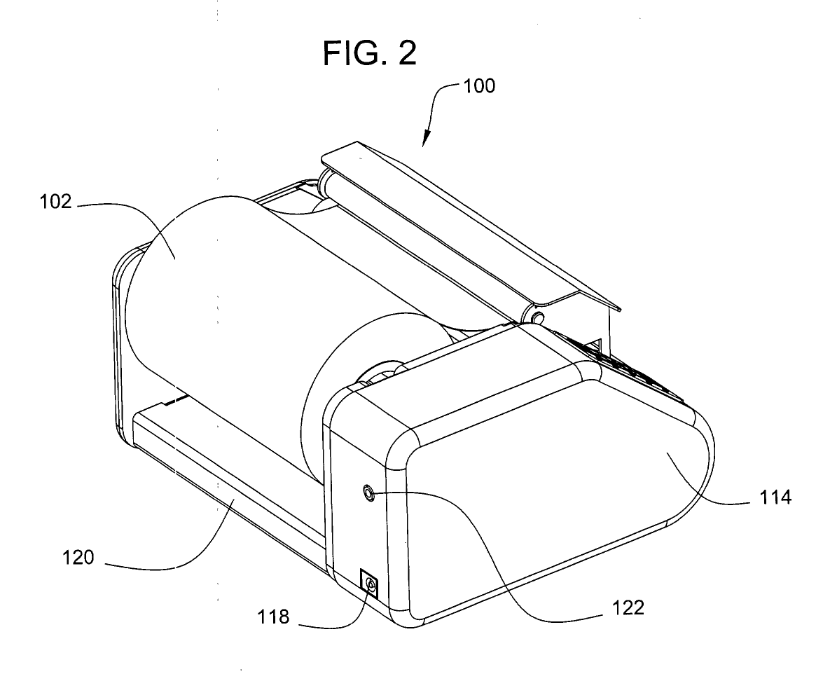

Illustrated in FIG. 2 is the rear of the foil dispensing machine 100. To provide power to the machine, port 118 is located at the rear and disposed through the back of side cover 114. Preferably, the machine is configured to operate off of standard 120V, 60 Hz power, though other configurations are contemplated. In some embodiments, to increase mobility of the machine and enable it to operate remotely from a power outlet, the machine may be equipped with a battery housing 120. The battery housing can accommodate a rechargeable battery that charges when port 118 is plugged into a wall outlet, or the battery housing can accommodate standard dry cells. To receive the cable from the foot pedal switch, connection outlet 122 is also provided and disposed through the side cover.

In accordance with the teachings of the present invention, there is provided a machine for dispensing pieces of metal foil from a roll of foil. To unwind the foil from the roll and dispense it from the machine, the machine includes a driver that cooperates with and is powered by a motor. Also included is a cutter that cuts the dispensed foil from the remainder of the roll. To regulate the length of foil dispensed, the machine includes a control device that governs the motor. The control device may be programmed to dispense pre-set lengths of foil or it may dispense foil under the immediate control of the stylist.

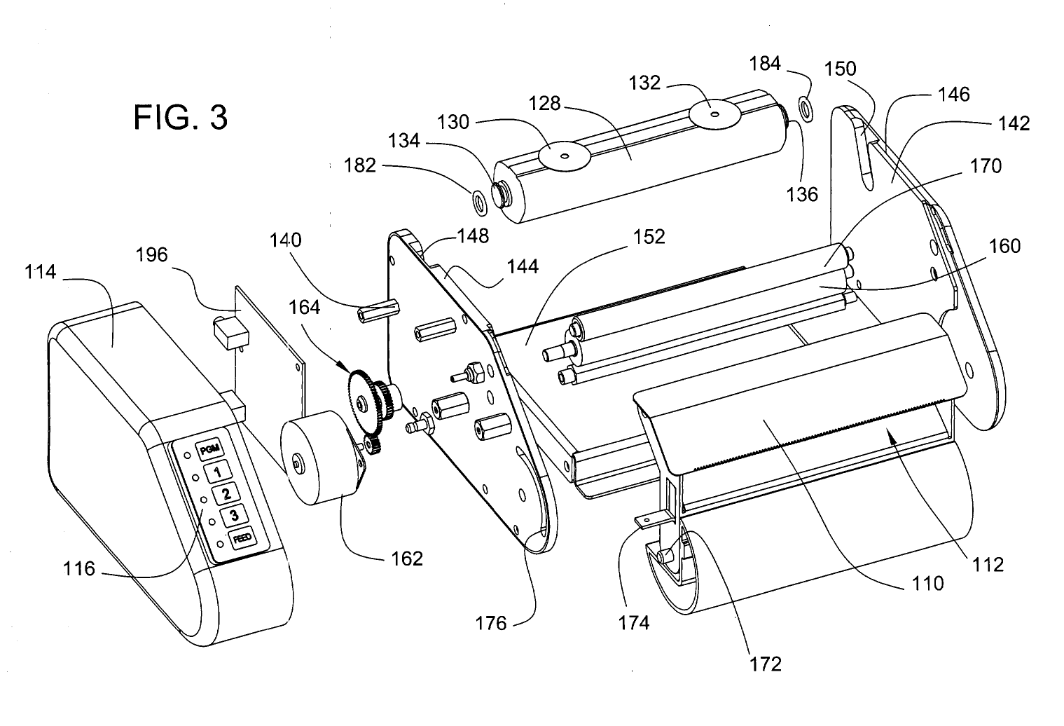

The components of the machine are illustrated in FIG. 3. To accommodate the foil roll, the machine includes an elongated support roller 128 that is generally cylindrical in shape with two opposing ends and can be manufactured from plastic. The hollow core of the foil roll can be inserted around the support roller. Accordingly, the length of the support roller 128 should be commensurate with the length of the foil roll. To firmly engage the support roller with the foil roll, two disks 130, 132 may be tangentially secured to the cylindrical surface of the support roller and partially cut into the hollow core when the support roller is inserted into the roll.

The opposed ends of the support roller 128 are each formed as a knob 134, 136 concentric with the cylindrical shape of the support roller but having a reduced diameter. To mount the support roller horizontally within the machine, a first side plate 140 and a second side plate 142 are provided at either of the two ends of the support roller and are generally perpendicular to the support roller. Cut into the upper edges 144, 146 of either side plate 140, 142 is a slot 148, 150 having a width that can accommodate the knobs 134, 136. Thus the support roller 128 is suspended between and can rotate with respect to the first and second side plates 140, 142. To prevent the support roller from unintentionally backing out of the slots 148, 150, the slots are preferably cut at a non-perpendicular angle with respect to the upper edges 144, 146. As such, the slots appear to angle forward with respect to the machine.

The first and second side plates 140, 142 can be manufactured from molded plastic or formed sheet metal. To brace the first and second side plates vertically within the machine, the lower portions of the plates are mounted to a base 152 by, for example, mechanical fasteners. The base 152 thereby holds the side plates 140, 142 vertically upright and functions to space the side plates apart from each other. Accordingly, the dimensions of the base should be commensurate with the dimensions of the support roller 128. In the embodiments that include a battery housing, the base can function as the battery housing.

Also suspended horizontally between the first and second side plates 140, 142 at a position forward of the support roller 128 is a cylindrical drive roller 160. The drive roller may be made from an elongated steel shaft that is covered by a rubber tube or similarly tacky material. To allow the drive roller to rotate with respect to the first and second side plates 140, 142, the uncovered ends of the drive roller may be journaled within bearings on the side plates. To rotate the drive roller, a motor 162 is attached to the first side plate 140 on the face opposite the face engaging the drive and support rollers 160, 128. The shaft of the motor 162 drives a gear train 164 composed of one or more gears that links the motor to the drive roller 160.

Parallel with and tangential to the drive roller 160 is a cylindrical follower roller 170 that may be made from plastic. The drive roller 160 and follower roller 170 are tangential to each other along their cylindrical surfaces. As is apparent, due to the tangential relationship, rotation of the drive roller 160 in one direction will cause the follower roller 170 to rotate in the opposite direction. The length of the tangential cylindrical surfaces of both the drive roller and support roller should be commensurate with both the support roller and the length of the foil roll. To support the follower roller, the follower roller can be braced along and rotatable with respect to the inside top portion of the front cover 110 above the slot 112.

While the support roller, drive roller, and follower roller have herein been described as cylindrical structures, other structures that achieve the described functions, such as rectangular shafts and co-axially aligned wheels, are also contemplated.

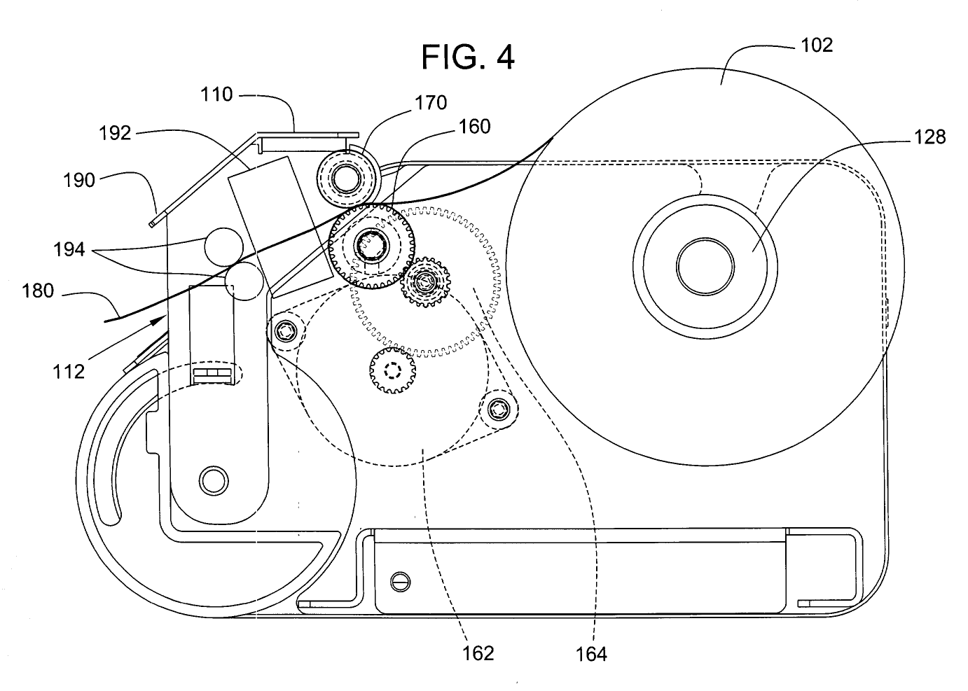

Illustrated in FIG. 4 is the feed path of the foil as it is unwound from the roll 102 located upstream and passed through the machine out the slot 112 downstream. A leading edge 180 is unwound from the foil roll 102 and inserted between the tangential drive and follower rollers 160, 170 and through the slot 112. As is apparent from FIG. 4, when the motor 162 begins to rotate the drive roller 160 via the gear train 164, the tacky surface of the drive roller 160, in cooperation with the follower roller 170, will grip to the foil and dispense the leading edge 180 through to the slot 112 while pulling the remaining foil on the roll. Because the support roller 128 is rotatably with respect to the machine and the support roller is firmly engaged within the hollow core, pulling the foil causes the roll and support roller to rotate allowing the foil to unwind from the roll. Once the desired amount of foil has been dispensed through the slot 112, the motor 162 is deactivated.

To reduce the likelihood that the foil will wrinkle or become distorted, the feed path between the roll and the slot should preferably be unencumbered. Additionally, where the length of the drive and follower rollers is commensurate with the length of the foil roll, the foil will be pulled evenly from the roll further preventing distortion of the foil along the feed path. The location of the drive and follower rollers with respect to the support roller straightens out the foil unwound from the roll.

A preferable feature included in the machine prevents the support roller from rotating once the motor is deactivated. More particularly, because of inertia in the rotating roll 102, the roll may continue to spin once the motor is deactivated causing the foil to unwind and bunch up within the feed path. Referring to FIG. 3, this can be prevented by attaching elastic O-rings 182, 184 around the knobs 134, 136 located at either end of the support roller 128 which produces frictional resistance between the knobs and the slots 148, 150. Importantly, the resistance produced by the O-rings should not be enough to stall or slow the motor or tear the foil but is sufficient to stop rotation of the support roller upon deactivation of the motor.

To detach the dispensed foil from the roll, a cutter is provided as part of the machine. As illustrated in FIG. 4, the cutter may be a stationary severing blade 190 attached to the outside of the front cover 110 above the slot 112. To cut the foil into separate pieces, the stylist pulls the dispensed foil upwards against the blade. Preferably, the blade is hidden within the front cover 114 and formed with a pitch suitable to cut the foil but not to present a cutting hazard to the stylist. In more complex embodiments, the cutter may be a moving cutting blade 192 that operates automatically without interaction by the stylist. The moving cutting blade 192 can be located within the front cover 110 downstream of the drive and follower rollers 160, 170. At an appropriate time, such as when the motor is deactivated, the moving blade 192 is brought into contact with the foil and cuts the foil from the roll into a separate piece. To hold the cut piece for the stylist, a pair of tangential pinch rollers 194 are provided within the front cover 110 between which the foil passes.

Because the cutter is located downstream of the drive and follower rollers, the leading edge of the foil will be held between the drive and follower rollers even after the cut piece has been removed. This maintains tension on the foil roll and, in conjunction with the O-rings, helps prevent the foil from becoming distorted within the feed path.

To control the amount of foil dispensed by the machine, the machine includes a control device that governs the motor. As is apparent from FIG. 4, the length of the foil dispensed is related the number of rotations made by the drive roller according to the equation:

Length=(Diameter of Roller*II*No. of Rotations)

providing no slipping occurs between the drive roller and the foil. Since the drive roller is linked to the motor through a gear train, the length of dispensed foil can be directly related to the number of rotations of the motor. By utilizing a stepper motor, DC motor, or similar motor, the control device can accurately govern the number of rotations made and thus the foil dispensed.

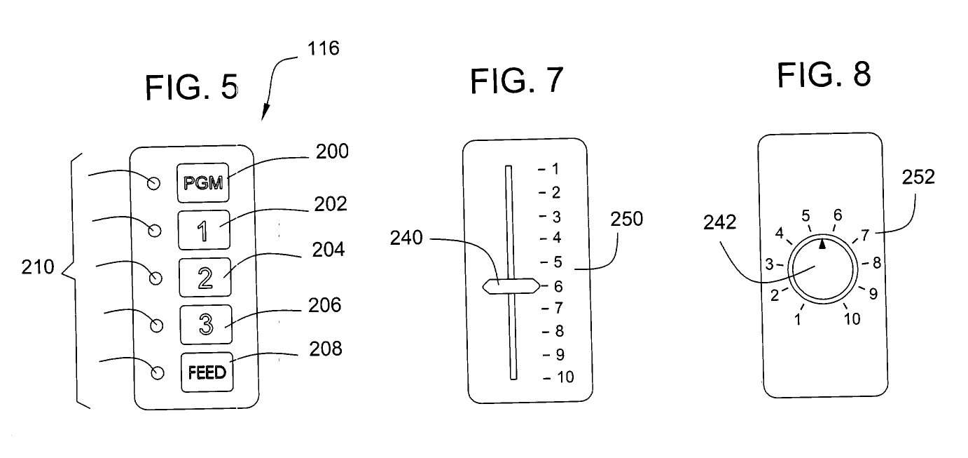

In some embodiments, the control device may be a programmable controller that can be programmed by the stylist to cause the machine to dispense preset lengths of foil. Referring to FIG. 3, the programmable controller includes a circuit board 196, that can be located within side cover 114 away from the foil path, and a user interface control panel 116, the two of which are connected by harness wires. The circuit board 196 includes circuitry that governs the rotation of motor 162 thereby determining how much foil is dispensed. Referring to FIG. 5, to program the programmable controller, the control panel 116 includes a plurality of keys 200, 202, 204, 206, 208, each having an associated light emitting diode (“LED”) 210. The keys can be buttons, toggles, or other electrical input switches.

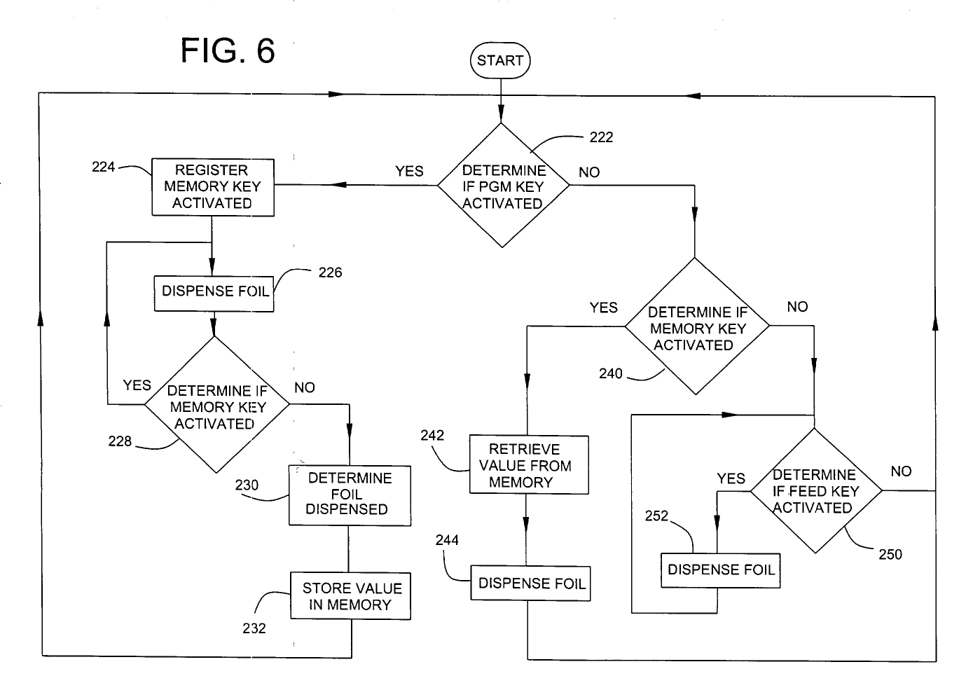

Illustrated in FIG. 6 are the details of one embodiment of how the programmable controller may operate in conjunction with the control panel of FIG. 5. Available on the control panel are a pgm key 200, three programmable memory keys 202, 204, 206, and a feed key 208. For instance, if a stylist wishes to program the machine to dispense a pre-set length of foil, the pgm key 200 is activated which alerts the controller (step 222) that one of the memory keys is about to be programmed. The stylist then activates a memory key 202, 204, 206 which is registered by the controller (step 224) and simultaneously causes the machine to begin dispensing foil (step 226). Once the desired amount of foil is dispensed, the stylist deactivates the selected memory key which is being monitored by the controller (step 228). The controller next determines the amount of foil dispensed (step 230) and stores that value in memory circuitry provided on the circuit board (step 232).

If the controller thereafter registers activation of the programmed memory key in the absence of activation of the pgm key (step 240), the controller will retrieve the previously stored value associated with the activated memory key (step 242). The controller then causes the machine to dispense the corresponding amount of foil (step 244).

If, however, the stylist wishes to dispense foil in a length that has not been programmed into any of the memory keys, the stylist activates the feed key 208. When the controller determines that the feed key has been activated (step 250), the controller causes the machine to begin dispensing foil (step 252) and continues to do so until the feed key is deactivated. The stylist can thereby create customized lengths of foil.

Referring to FIG. 5, each key is associated with a LED 210. The LED's facilitate programming of the controller by lighting up to indicate which key is currently activated. For instance, if the stylist is attempting to program the second memory key 204, the LED's associated with the pgm key 200 and the second memory key 204, and only those two, should be illuminated. Additionally, the machine may include a foot pedal switch 104 as illustrated in FIG. 1. In an embodiment, the controller may be set so that activation of the foot pedal switch 104 triggers one of the functions associated with the keys on the control panel 116. Referring to FIG. 5, to indicate to the stylist which particular function will be activated by the foot pedal switch, the appropriate LED should remain lit.

In another embodiment, the machine may include a feature that allows the machine to automatically dispense more foil each time the previously dispensed foil is cut from the roll. As illustrated in FIG. 1, a photosensitive eye 196 may be located on the front cover 110 below the slot 112. The photosensitive eye would register removal of the foil previously dispensed through the slot and notify the control device. The control device in turn would cause the machine to dispense more foil. Advantageously, the machine would continuously present a new piece of foil without intervention by the stylist.

Referring to FIGS. 7 and 8, in other embodiments, to reduce the cost of the machine, the control device can be composed of a less elaborate slider switch 240 or dial 242. Adjusting the slider switch or dial with respect to a scale 250, 252 causes the machine to dispense a corresponding length of foil each time the machine is activated.

After the foil has been dispensed from the machine, the stylist can place the cut piece adjacent to a previously grouped lock of hair. Coloring solution is then applied to the lock and the foil piece is crimped or folded about the colored hair. To continue the coloring process with the next group of hair, the stylist simply actives the machine again to dispense the next piece of foil.

Referring to FIG. 3, to load a roll of foil into the machine, the support roller 128 can be removed from the machine by lifting it upwards and sliding the knobs 134, 136 out along the slots 148, 150. The support roller can then be inserted into the hollow core of the foil roll and placed back into the machine. Referring to FIG. 4, the leading edge of the foil 180 is inserted between the drive roller 160 and the follower roller 170. To facilitate the insertion of foil between the rollers, the front cover 110 that accommodates the follower roller 170 can be pivoted forward with respect to the machine. Specifically, as shown in FIG. 3, rod 172 of the front cover 110 is pivotally braced between the two side plates 140, 142. To guide the front cover as it pivots forward from its vertically upright position, tab 174 extends from the edge of the front cover and engages a crescent shaped slot 176 cut through side plate 140. When the front cover 110 is pivoted forward, the follower roller 170 is lifted away from the drive roller 160 allowing insertion of the foil therebetween.

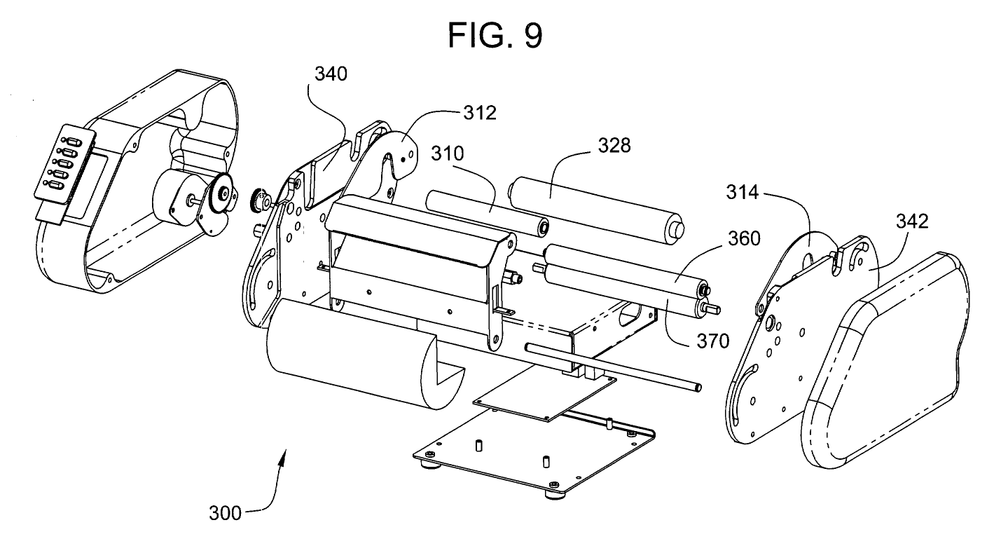

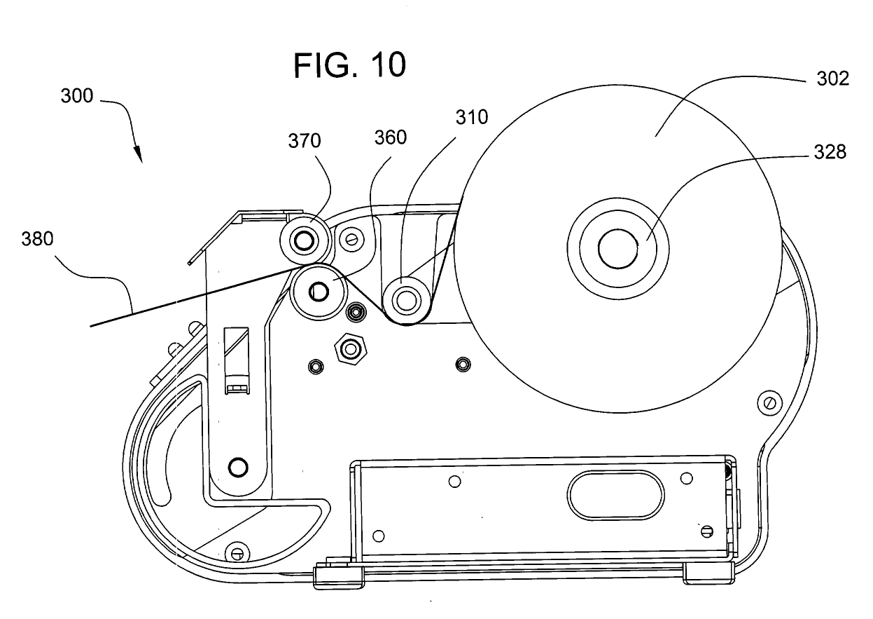

Illustrated in FIGS. 9 and 10 are another embodiment of a machine 300 for dispensing foil which includes a cylindrical tensioning roller 310 located between the support roller 328 and the drive and follower rollers 360 and 370. The function of the tensioning roller 310 is to keep tension on the foil roll 302 and prevent the foil 380 from bunching up along the feed path. As illustrated in FIG. 9, the tensioning roller 310 is suspended between a first support arm 312 and a second support arm 314 which, in turn, are pivotally attached to a respective first side plate 340 and a second side plate 342. Referring to FIG. 10, preferably, the side arms are spring biased so that the tensioning roller 310 maintains a downward force on the foil 380.

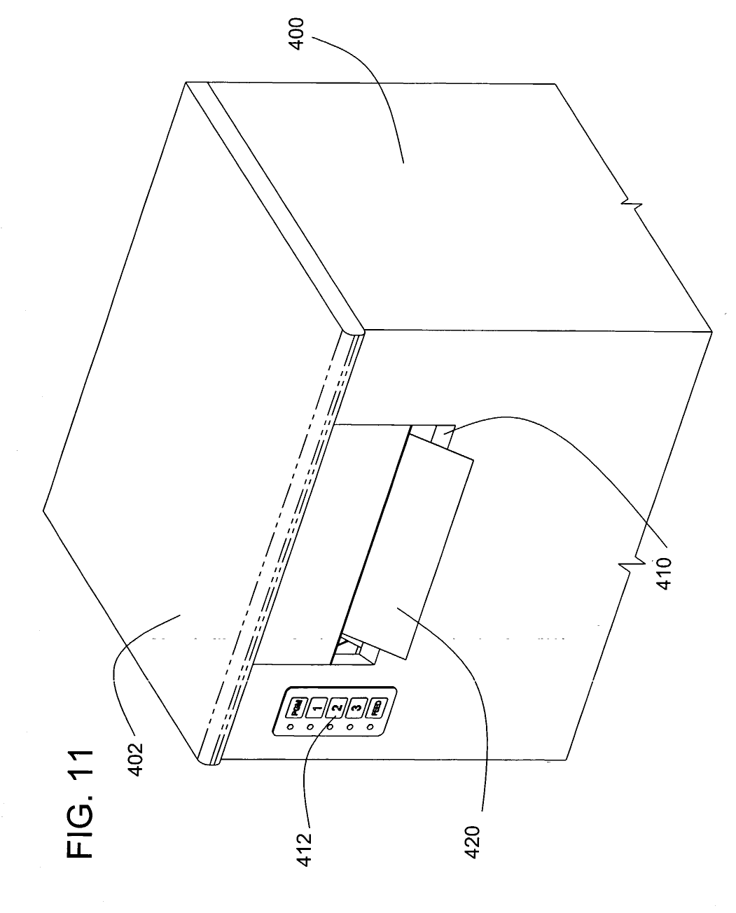

Illustrated in FIG. 11 is another embodiment of a foil dispensing machine wherein the machine is incorporated into a piece of furniture 400. Preferably, the furniture is functionally designed for placement inside a hair salon. For example, the furniture can be designed as a counter with a flat top 402 upon which the stylist can place scissors, combs and other cosmetic accessories. The furniture further includes a slot 410 through which the foil pieces 420 are dispensed and an operator interface control panel 412. In some embodiments, the furniture can be placed upon wheels to make it mobile.

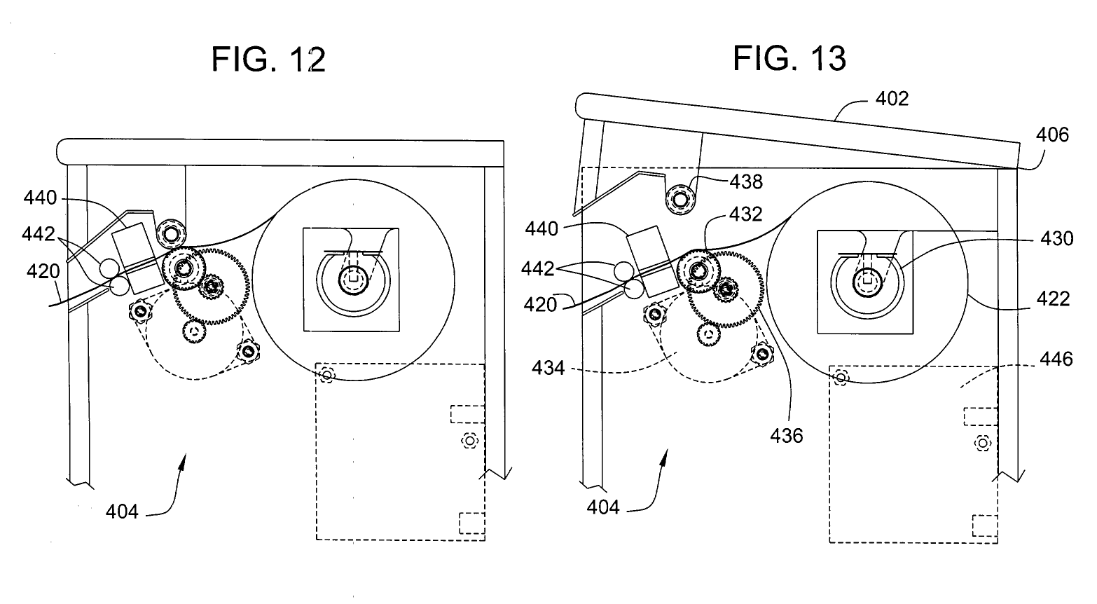

Illustrated in FIGS. 12 and 13 is a hollow internal cavity 404 defined by the furniture. The foil roll 422 is accommodated in the internal cavity along a rotatable support roller 430. Also located within the furniture downstream of the support roller 430 are a drive roller 432 linked to a motor 434 via a gear train 436 and a follower roller 438 tangential to the drive roller. Downstream of the drive and follower rollers are a moving cutting blade 440 and a pair of pinch rollers 442. Also located within the furniture is a printed circuit board 446 that includes the circuitry for controlling the machine. As is apparent, the machine can dispense foil in the same manner as previously described. To access the internal cavity 404 for replacing the foil roll 422, the top 402 is pivotally attached to the rest of the furniture at hinge 406.

Thus, the present invention provides a foil dispensing machine for use in the hair styling and highlighting business. The machine can accommodate a roll of foil, unwinds the foil via a motor and a drive roller, and dispenses the unwound foil. Then either the stylist or the machine itself can cut the foil at a desired length. The machine includes a control device that governs the motor and can be set to control the length of foil dispensed.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments would become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A machine for dispensing foil from a roll, the machine comprising:
a supporter for accommodating the roll such that the roll may rotate with respect to the machine;
a drive roller for removing foil from the roll;
a motor linked to the drive roller;
a control device governing the motor; and
a cutter to cut foil from the remainder of the roll;

2. The machine of claim 1, wherein the supporter further comprises a roller dimensioned to be inserted through a core of the roll.

3. The machine of claim 2, wherein the support roller is configured to rotate along with the roll with respect to the machine.

4. The machine of claim 1, wherein the cutter further comprises a severing blade located downstream of the drive roller.

5. The machine of claim 1, wherein the cutter further comprises a cutter mechanism located down stream of the drive roller that includes a moving blade to cut the foil from the remainder of the roll.

6. The machine of claim 5, where the machine further comprises a plurality of pinch rollers for holding foil that has been cut, at least two of the plurality of pinch rollers are tangential to one another the plurality of pinch rollers located downstream of the cutter mechanism.

7. The machine of claim 1, further comprising a follower roller tangential to the drive roller and cooperating with the drive roller to remove the foil from the roll.

8. The machine of claim 1, wherein the control device comprises a programmable controller that can be programmed to cause the machine to dispense a set length of foil.

9. The machine of claim 8, wherein the control device further comprising a user interface control panel including a plurality of buttons for programming the programmable controller.

10. The machine of claim 1, wherein the control device further comprises an adjustable switch that can be set to cause the machine to dispense a set length of foil.

11. The machine of claim 1, wherein the control device further comprises a foot pedal switch.

12. The machine of claim 1, wherein the control device further comprises a photosensor located on the machine monitoring the dispensed foil.

13. The machine of claim 1, further comprising a unit of furniture, the machine incorporated with the unit of furniture.

14. The machine of claim 1, further comprising cover, the machine incorporated with the cover.

15. A method of dispensing a piece of metal foil from a roll of foil; the method comprising:
inserting onto a support roller the roll of metal foil;
inserting a leading edge of the metal foil between a drive roller and a follower roller;
unwinding the foil from the roll by rotating the driver roller;
dispensing the foil from between the driver roller and the follower roller; and
cutting the dispensed foil from the remaining foil on the roll.

16. The method of claim 1, wherein the drive roller is linked to a motor.

17. The method of claim 1, wherein the motor is governed by a control device.

18. The method of claim 1, wherein the control device comprises a programmable controller programmed to dispense a set length of foil.

19. A method of coloring hair comprising:
providing a foil dispensing machine accommodating a roll of foil;
activating the machine to dispense a piece of the foil from the roll;
placing the dispensed piece of foil adjacent a lock of hair;
applying a coloring solution to the lock of hair; and
folding the dispensed piece of foil about the lock of hair.

20. The method of claim 19, wherein the step of activating the machine further comprises activating a motor that unwinds foil from the roll.

21. The method of claim 19, further comprising the step of programming the machine to dispense foil at a pre-set length.
